(19) United States
(12) Patent Application Publication
(10) Pub. No.: US 2003/0138684 A1
(43) Pub. Date: Jul. 24, 2003

(54) REACTANT AIR PATHWAY WITH AN ELECTRICAL CONTACT

(76) Inventors: Lawrence A. Tinker, Woodstock, GA (US); Dennis Sieminski, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/546,863

(22) Filed: Apr. 10, 2000

Related U.S. Application Data
(63) Continuation-in-part of application No. 09/215,879, filed on Dec. 18, 1998, now abandoned.

(51) Int. Cl. H01M 12/06; H01M 2/12; H01M 2/10

(52) U.S. Cl. 429/27; 429/86; 429/178; 429/71; 429/123; 429/88

(57) ABSTRACT

An electronic device driven by a metal-air battery. The metal-air battery has a battery diffusion pathway and a battery terminal. The electronic device includes a device diffusion pathway in communication with the diffusion pathway of the metal-air battery and a device battery terminal in contact with the device diffusion pathway. The battery device terminal also is in contact with the battery terminal of the metal-air battery so as to communicate electrical power from the metal-air battery to the electronic device.

This is a continuation-in-part of U.S. application Ser. No. 09/215,879, entitled “Diffusion Controlled Air Vent With An Interior Fan”, filed Dec. 18, 1998.

### TECHNICAL FIELD

The present invention relates to an air-manager for a metal-air power supply and more particularly relates to an air manager using diffusion tubes with an electrical connection positioned therewith.

### BACKGROUND OF THE INVENTION

Generally described, a metal-air cell includes one or more oxygen electrodes separated from a metallic anode by an aqueous electrolyte. A metal-air cell also can include one or more oxygen electrodes that cooperate with a paste-like electrolyte in which metallic anode particles are suspended. During operation of a metal-air cell, such as a zinc-air cell, oxygen from the ambient air and water from the electrolyte are converted at the oxygen electrode to hydroxide ions. Zinc is oxidized at the anode and reacts with the hydroxide ions such that water and electrons are released to provide electrical energy.

Metal-air cells have been recognized as a desirable means for powering portable electronic equipment, such as personal computers, camcorders and telephones. As compared to conventional electrochemical power sources, metal-air cells provide relatively high power output and long lifetime with relatively low weight. These advantages are due in part to the fact that metal-air cells utilize oxygen from the ambient air as the reactant in the electrochemical process as opposed to a heavier material such as a metal or a metallic composition.

One drawback, however, with the current design of metal-air cells is that the cells tend to be somewhat larger in size than conventional electrochemical power sources. This size constraint is caused, in part, by the requirements of having an anode, a cathode, an electrolyte, a cell casing of some sort, and an air manager or an air passageway of some sort to provide the reactant air to the cell. These elements all take up a certain amount of valuable space.

For example, a multiple cell metal-air battery pack housing traditionally has at least one air inlet passageway and at least one air outlet passageway positioned adjacent to an interior fan. The air passageways are generally sealed with mechanical air doors to prevent the transfer of air and humidity into or out of the housing during periods of non-use. An example of a mechanical air door system is shown in U.S. Pat. No. 4,913,983 to Chieky. This reference describes a fan used to supply a flow of ambient air to a pack of metal-air cells within the battery housing. When the battery pack is turned on, the mechanical air doors adjacent to an air inlet and an air outlet are opened and the fan is activated to create the flow of air into, through, and out of the housing. The air doors are then closed when the battery is turned off to isolate the cells from the environment. Although the mechanical air doors may limit the transfer of oxygen, water vapor, and contaminants into and out of the housing, such mechanical air doors add complexity to the battery housing itself and, inevitably, increase the size and cost of the overall battery pack.

In attempting to design smaller metal-air cells and batteries, one concern is to provide a sufficient amount of air to operate the cells at their desired capability while also preventing too much air from reaching the cells during periods of non-use. A vast improvement in air manager technology is found in commonly owned U.S. Pat. No. 5,691,074, entitled “Diffusion Controlled Air Vent for a Metal-Air Battery” to Pedicini. Pedicini discloses, in one embodiment, a group of metal-air cells isolated from the ambient air except for an inlet and an outlet passageway. These passageways may be, for example, elongate tubes. An air-moving device positioned within the housing forces air through the inlet and outlet passageways to circulate the air across the oxygen electrodes and to refresh the circulating air with ambient air. The passageways are sized to allow sufficient airflow therethrough while the air mover is operating but also to restrict the passage of water vapor therethrough while the passageways are unsealed and the air mover is not operating.

When the air mover is off and the humidity level within the cell is relatively constant, only a very limited amount of air diffuses through the passageways. The water vapor within the cell protects the oxygen electrodes from exposure to oxygen. The oxygen electrodes are sufficiently isolated from the ambient air by the water vapor such that the cells have a long “shelf life” without sealing the passageways with a mechanical air door. These passageways may be referred to as “diffusion tubes”, “isolating passageways”, or “diffusion limiting passageways” due to their isolating capabilities

Specifically, FIG. 1 herein shows one embodiment of the metal-air battery disclosed in Pedicini. The metal-air battery 10 includes a plurality of cells 15 enclosed within a housing 20. The housing 20 isolates the cells 15 from the ambient air with the exception of a plurality of ventilation openings 25. A single air inlet opening 30 and a single air outer opening 35 are utilized herein. A circulating fan 40 is provided for convective air flow both into and out of the housing 20 and to circulate and mix the gases within the housing 20. The arrows 45 shown in FIG. 1 represent a typical circulation of the gases into, out of, and within the housing 20 to provide the reactant air to the cells 15. The fan 40 forces the air through the air inlet 30, into an air plenum inlet 55, across the cells 15, out of an air plenum outlet 65, and either then to recirculate within the housing 20 or to pass out of the air outlet 35. U.S. Pat. No. 5,691,074 is incorporated herein by reference.

The isolating passageways act to minimize the detrimental impact of humidity on the metal-air cells, especially while the air-moving device is off. A metal-air cell that is exposed to ambient air having a high humidity level may absorb too much water through its oxygen electrode and fail due to a condition referred to as “flooding.” Alternatively, a metal-air cell that is exposed to ambient air having a low humidity level may release too much water vapor from its electrolyte through the oxygen electrode and fail due to a condition referred to as “drying out.” The isolating passageways limit the transfer of moisture into or out of the metal-air cells while the air moving device is off, so that the negative impacts of the ambient humidity level are minimized.

The efficiency of the isolating passageways in terms of the transfer of air and water into and out of a metal-air cell can be described in terms of an “isolation ratio.” The “isolation ratio” is the rate of the water loss or gain by the cell while its oxygen electrodes are fully exposed to the ambient air as compared to the rate of water loss or gain by a cell while its oxygen electrodes are isolated from the ambient air except through one or more limited openings. For example, given identical metal-air cells having electrolyte solutions of approximately thirty-five percent (35%) KOH in water, an internal relative humidity of approximately fifty percent (50%), ambient air having a relative humidity of approximately ten percent (10%), and no fan-forced circulation, the water loss from a cell having an oxygen electrode fully exposed to the ambient air should be more than 100 times greater than the water loss from a cell having an oxygen electrode that is isolated from the ambient air except through one or more isolating passageways of the type described above. In this example, an isolation ratio of more than 100 to 1 should be obtained.

In accordance with the above-referenced example from Pedicini, the isolating passageways function to limit the amount of oxygen that can reach the oxygen electrodes when the fan is off and the internal humidity level is relatively constant. This isolation minimizes the self-discharge and leakage or drain current of the metal-air cells. Self-discharge can be characterized as a chemical reaction within a metal-air cell that does not provide a usable electric current. Self-discharge diminishes the capacity of the metal-air cell for providing a usable electric current. Self-discharge occurs, for example, when a metal-air cell dries out and the zinc anode is oxidized by the oxygen that seeps into the cell during periods of non-use. Leakage current, which is synonymous with drain current, can be characterized as the electric current that can be supplied to a closed circuit by a metal-air cell when air is not provided to the cell by an air moving device. The isolating passageways as described above may limit the drain current to an amount smaller than the output current by a factor of at least fifty (50) times.

In addition to humidity differentials, the isolation ratio appears to be dependent upon the pressure differential that can be induced by the fan or other type of air mover and the degree to which the isolating passageways slow the diffusion of air and water when the fan is off. In the past, air moving devices used in metal-air batteries have been bulky and expensive relative to the volume and cost of the metal-air cells. Although a key advantage of metal-air cells is their high energy density resulting from the low weight of the oxygen electrode, this advantage is compromised by the space and weight required by an effective air-moving device. Space that otherwise could be used for battery chemistry to prolong the life of the battery must be used to accommodate an air-moving device. Increasing the size and power of the fan or lengthening the isolating passageways to increase the isolation ratio, however, generally would lead one to increase the size of the cell or the battery. In other words, attempts to reduce the size of the cell or the battery have been somewhat limited by the need for an adequate isolation ratio and an adequately sized fan or air mover. This loss of space can be critical to attempts to provide a practical metal-air cell in small enclosures such as the “AA” cylindrical size now used as a standard in many electronic devices.

There is a need, therefore, for a metal-air cell and/or battery pack that is as small and compact as possible, that occupies less of the volume available for battery chemistry, and provides adequate power with an adequate isolation ratio. These advantages must be accomplished in a metal-air cell or battery pack that provides the traditional power and lifetime capabilities of a metal-air cell in a low cost, efficient manner.

### SUMMARY OF THE INVENTION

The present invention is directed towards an improved metal-air cell or battery for use with an electronic device. Advantageously, the electrical contacts of the metal-air battery and/or the electronic device are positioned in contact with the diffusion passageways. The metal-air battery and/or the electronic device thus may be smaller than known devices while still providing superior airflow and adequate humidity control. The present invention thus provides an adequate isolation ratio in a compact metal-air cell or battery pack.

One embodiment of the present invention includes the use of an electronic device driven by a metal-air battery. The metal-air battery has a battery diffusion pathway and a battery terminal. The electronic device includes a device diffusion pathway in communication with the diffusion pathway of the metal-air battery and a device battery terminal in contact with the device diffusion pathway. The battery device terminal also is in contact with the battery terminal of the metal-air battery so as to communicate electrical power from the metal-air battery to the electronic device.

Specifically, the device battery terminal may include an electrically conductive material. The device battery terminal may be a ring element positioned in contact with or within the device diffusion pathway. The device battery terminal also may be a unitary element with the device diffusion pathway. The device diffusion pathway may include a fan positioned therein. The electronic device also may have a battery port for mating with the metal-air battery. The electronic device may have a number of diffusion pathways and a number of battery terminals such that each pathway may have a terminal. Specifically, an input diffusion pathway with a first battery terminal and an output diffusion pathway with a second battery terminal may be used.

Another embodiment of the present invention provides a metal-air battery for powering an electronic device. The electronic device has a device diffusion pathway and a device battery terminal. The metal-air battery includes a diffusion pathway in communication with the device diffusion pathway of the electronic device and a battery terminal in contact with the diffusion pathway. The metal-air battery communicates electrical power to the electronic device via the device battery terminal and the battery terminal. Specifically, the battery terminal may include an electrically conductive material. The battery terminal may include a ring element positioned in contact with or about the diffusion pathway. The input battery terminal also may be a unitary element with the diffusion pathway. The metal-air battery may have a number of diffusion pathways and a number of battery terminals such that each pathway may have a terminal. Specifically, an input diffusion pathway with a first battery terminal and an output diffusion pathway with a second battery terminal may be used.

A further embodiment of the present invention provides for an electronic device. The electronic device includes a battery port and a device intake diffusion pathway with a device battery terminal. The electronic device further includes a metal-air battery positioned within or adjacent to the battery port. The metal-air battery may have a battery diffusion pathway with a battery terminal for contacting the device battery terminal. The battery diffusion pathway may be sized for mating with the device diffusion pathway such that air and electrical power pass along the device diffusion pathway and the battery diffusion pathway.

A further embodiment of the present invention provides for a metal-air cell. The metal-air cell includes a chemistry body. The chemistry body includes a body diffusion pathway with a body electrical terminal. The metal-air cell also includes an air manager cap. The air manager cap includes a cap diffusion pathway with a cap electrical terminal. The cap diffusion pathway and the body diffusion pathway are sized for engagement with each other. The metal-air cell may further have an air movement device positioned within the cap diffusion pathway. The chemistry body is detachable from the air manager cap. The cap diffusion pathway may include an air inlet and a cap mating connector. Similarly, the body diffusion pathway may include an air outlet and a body mating connector. The electrical terminals may include an electrically conductive material. The electrical terminals may include a ring element positioned in contact with the diffusion pathways or the electrical terminals may be a unitary element with the diffusion pathways. The cap and the body may have a number of diffusion pathways and a number of electrical terminals. Each diffusion pathways may have an electrical terminal.

Other objects, features, and advantages of the present invention will become apparent upon review of the following detailed description of the preferred embodiments of the invention, when taken in conjunction with the drawings and the appended claims.

### BRIEF DESCRIPTION OF THE DRAWINGS

FIG. 1 shows one embodiment of the metal-air battery using diffusion tubes described in commonly-owned U.S. Pat. No. 5,691,074.

FIG. 2 is a cross-sectional view of a diffusion tube with an internal fan.

FIG. 3 is a cross-sectional view of the diffusion tube with an internal fan taken along line 3-3 of FIG. 2.

FIG. 4 is a cross-sectional view of a diffusion tube with a central bulge.

FIG. 5 is a cross-sectional of a diffusion tube with internal fan blades and an external motor.

FIG. 6 is a cross-sectional view of the diffusion tube with the internal fan blades and the external motor taken along line 6-6 of FIG. 5.

FIG. 6B is cross-sectional view of the diffusion tube with the internal fan blades surrounded by a plurality of electromagnets.

FIG. 7 is a cross-sectional view of an intake diffusion tube with internal fan blades, an exhaust diffusion tube with internal fan blades, and a common motor.

FIG. 8 is a cross-sectional view of the metal-air battery with the diffusion tubes and the common motor of FIG. 7.

FIG. 9 is a cross-sectional view of a diffusion tube with internal fan blades and a pair of shape memory alloy wires.

FIG. 10 is a cross-sectional view of a metal-air battery with a pair of convoluted intake and exhaust tubes with internal fan blades.

FIG. 11 is a cross-sectional view of the metal-air battery with the pair of convoluted intake and exhaust tubes with internal fan blades taken along line 11-11 of FIG. 10.

FIG. 12 is a cross-sectional view of a metal-air battery with a pair of collapsible intake and exhaust tubes with internal fan blades.

FIG. 13 is a cross-sectional view of an electronic device with a diffusion tube and an internal fan mated with a metal-air battery with intake and exhaust diffusion tubes.

FIG. 14 is a cross-sectional view of an “AA” size metal-air battery with an air manager cap having a diffusion tube with an internal fan.

FIG. 15 is a cross-sectional view of an electronic device with a diffusion tube and an internal fan mated with a metal-air battery with intake and exhaust diffusion tubes.

FIG. 16 is a cross-sectional view of the electrical device diffusion tube with the battery terminal.

FIG. 17 is a cross-sectional view of the metal-air battery diffusion tube with the battery terminal.

FIG. 18 is a cross-sectional view of an “AA” size metal-air battery with an air manager cap having a diffusion tube with an internal fan.

### DETAILED DESCRIPTION OF THE INVENTION

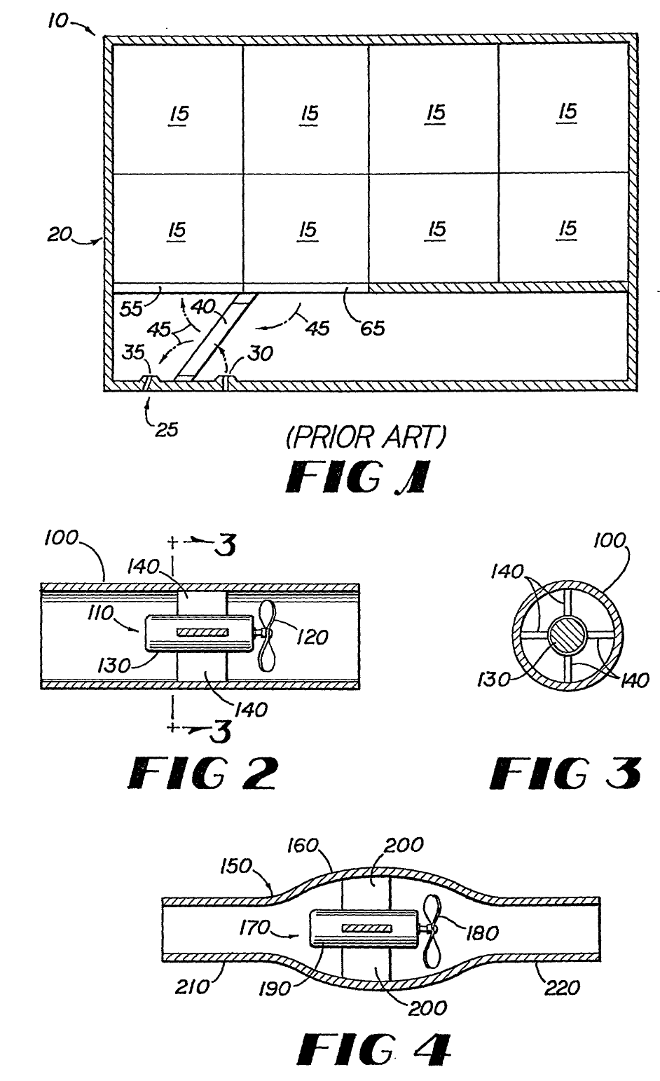

Referring now in more detail to the drawings, in which like numerals refer to like parts throughout the several views, FIGS. 2 and 3 show an isolating or a diffusion pathway in the shape of a diffusion tube 100 for use with the present invention. The diffusion tube 100 may be used with the plurality of cells 15 enclosed within the housing 20 of the metal-air battery 10 or any conventional type of metal-air cell 15 or battery 10. The diffusion tube 100 is preferably, but not necessarily, cylindrical. Any cross-sectional shape that provides the desired isolation is suitable. As with the diffusion tubes described in U.S. Pat. No. 5,691,074, the diffusion tube 100 is sized to eliminate substantially air flow therethrough when a fan 110 or an air mover is turned off while permitting adequate air flow therethrough when the fan 110 is on. Specifically, the diffusion tube 100 has a length of greater dimension than its width, and more preferably, the length is greater than about twice the width. The use of larger ratios between length and width are preferred. Depending upon the nature of the metal-air cells 15, the ratio can be more than 200 to 1. However, the preferred ratio of length to width is about 10 to 1.

Positioned withiin the diffusion tube 100 is the fan 110. The fan 110 is a conventional air moving device. For example, although the term “fan” 110 is used herein, the air movement device may include other conventional devices such as a pump, bellows, and the like known to those skilled in the art. The fan 110 includes a plurality of fan blades 120 driven by a conventional electric motor 130 or similar device. The electric motor 130 draws power from the cell or the battery itself. The fan 110 is positioned within the diffusion tube 100 by one or more support struts 140 or similar types of anchoring devices. The support struts 140 anchor the fan 110 within the middle of the diffusion tube 100. By placing the fan 110 within the diffusion tube 100, the fan 110 moves air through the diffusion tube 100 much in the same manner as a blade moves air within a turbine.

In accordance with a first exemplary embodiment of the present invention, the diffusion tube 100 functions as both an inlet and an outlet because fan 110 causes reciprocating airflow through the diffusion tube 100. In an alternating fashion, ambient air flows through the diffusion tube 100 toward the cells 15 or the oxygen electrodes while air that is at least partially depleted of oxygen flows through the diffusion tube 100 away from the cells 15 or the oxygen electrodes. Further, multiple diffusion tubes 100 can be utilized in the aggregate such that the diffusion tubes 100 function in unison as inlets, and thereafter function in unison as outlets, in an alternating fashion. When air is provided to the cells 15 or the oxygen electrodes by a reciprocating airflow through one or more diffusion tubes 100, it is preferable for the fan 110 to cause at least some mixing of air proximate to the cells 15 or the oxygen electrodes. This mixing ensures that the cells 15 or the electrodes are exposed to a relatively uniform distribution of oxygen.

In accordance with a second exemplary embodiment of the present invention, at least two diffusion tubes 100 are utilized to provide airflow to the cells 15 in response to operation of fan 110. The diffusion tubes 100 and the fan 110 are arranged so that one of the diffusion tubes 100 functions as an inlet through which ambient air flows toward the cells 15 or the oxygen electrodes and another of the diffusion tubes 100 functions as an outlet through which oxygen depleted air flows away from the cells 15 or the oxygen electrodes. Further, a first group of diffusion tubes 100 may function together as inlets and a second group of diffusion tubes 100 may function together as outlets.

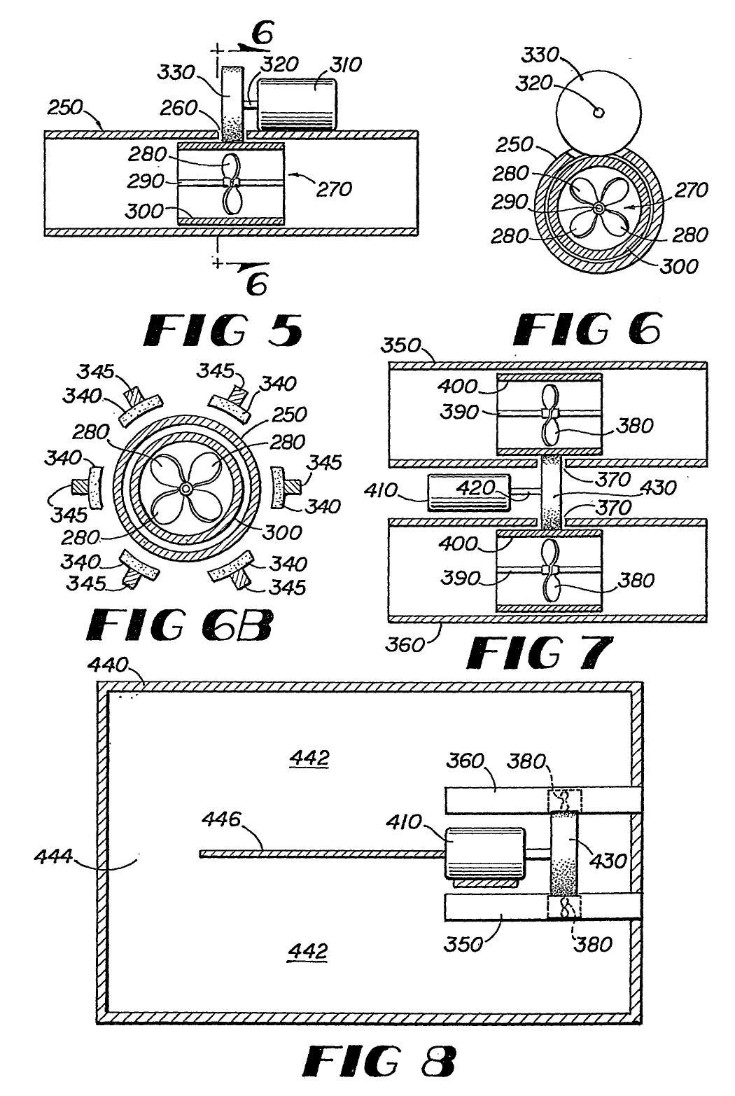

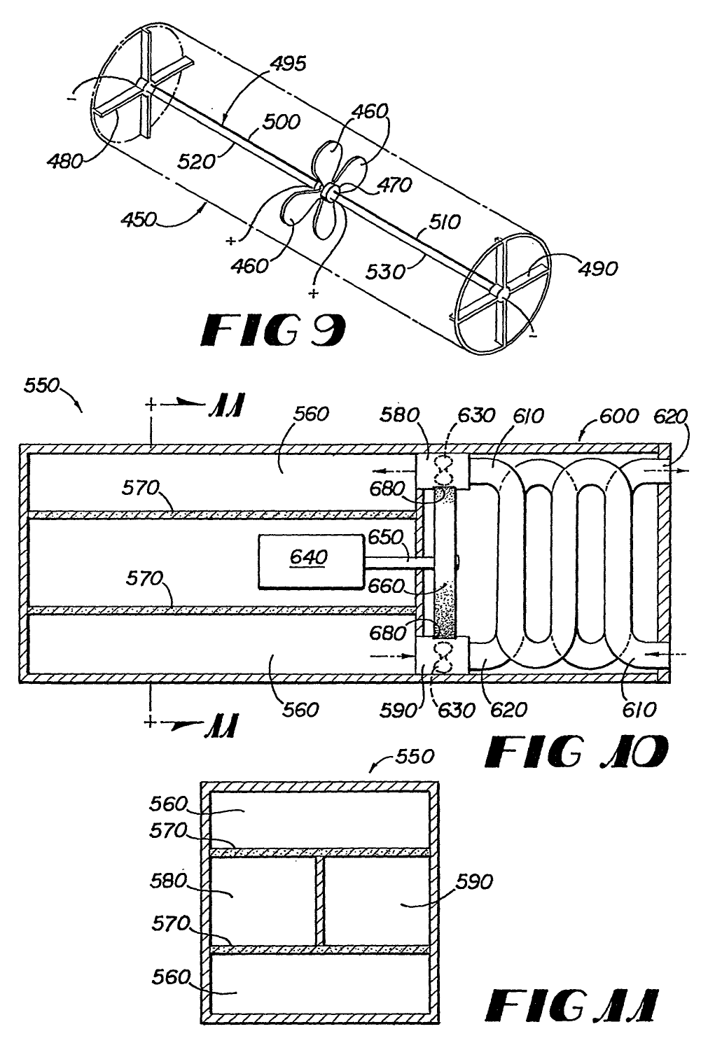

FIG. 4 shows an alternative embodiment of the diffusion tube 100. In this embodiment, a diffusion tube 150 has a central bulge 160 into which a fan 170 is mounted. The bulge 160 is of sufficient diameter so as to permit the positioning of the fan 170 therein. As in the embodiment of FIGS. 2 and 3, the fan 170 includes a plurality of fan blades 180 driven by an electrical motor 190 or a similar type of device. The fan 170 is supported within the diffusion tube 150 by one or more support struts 200. In this embodiment, the diffusion tube 150 has a first diffusion section 210 and a second diffusion section 220 The diffusion sections 210, 220 both have a diameter or a width that is less than their respective lengths. The length and diameter of the sections 210, 220 of the diffusion tube 170 provide adequate isolation of the cells from the external environment. Likewise, the bulge 160 allows for a relatively larger or more powerful fan 170 to move an adequate amount of air while providing an adequate amount of isolation for the cells.

FIGS. 5 and 6 show a further embodiment of the present invention. This embodiment shows a diffusion tube 250 with a small gap or notch 260 substantially adjacent to one end of the tube 250. The notch 260 is sufficiently close to one end of the tube 250 such that the remainder of the tube 250 can perform its diffusion task without significant transfer of air or water through the notch 260. Positioned within and about the diffusion tube 250 is a fan 270. As described above, the fan 270 has a plurality of fan blades 280 mounted on their inner ends to a hub 290. The fan blades 280 are also attached rigidly on their outer ends to a fan blade sleeve 300. The fan blade sleeve 300 is sized to fill substantially the notch 260. Positioned outside of the diffusion tube 250 and adjacent to the notch 260 is an electrical motor 310 or a similar type of device as described above. The motor 310 has a drive shaft 320 connected to a friction rotor 330 or other type of drive mechanism. The friction rotor 330 is positioned within the notch 260 such that the friction rotor 330 rotates the fan blade sleeve 300 by friction to turn the fan blades 280.

By placing the motor 310 outside of the diffusion tube 250, the diameter of the diffusion tube 250 can be relatively small because the size of the motor 310 is not a concern. Likewise, the motor 310, does not need to be unduly miniaturized. Although such small motors are commercially available, these motors are more expensive than conventionally sized motors. The fan blades 280 can be injection molded to extremely small diameters and sized so as to fit the desired diameter of the diffusion tube 250. In addition to the friction drive described above, other conventional methods to drive the fan blades 280 may be used. These conventional methods include the use of gears, pulleys, magnetic coupling and similar methods known by those skilled in the art to drive loads that are not in line with the drive motor shaft 320.

For example, FIG. 6B shows the fan blades 280 mounted within the fan blade sleeve 300. In this case, either or both the fan blades 280 and the fan blade sleeve 300 are made from a metal, a metallic coating, or otherwise responsive to electromagnetics. Surrounding the diffusion tube 250 adjacent to the fan blade sleeve 300 is a plurality of electromagnets 340 with motor windings 345. The electromagnets 340 are synchronized to rotate the fan blades 280 or the fan blade sleeve 300 in a given rotational direction. The electromagnets 340 may be positioned on both an intake and an exhaust diffusion tube 250 or the electromagnets 340 may be reversible such that only one diffusion tube 250 is used.

A further embodiment on this concept is shown in FIG. 7. This embodiment uses an intake diffusion tube 350 and an exhaust diffusion tube 360. Each diffusion tube 350, 360 has a notch 370 therein as is shown in FIGS. 5 and 6. Each diffusion tube 350, 360 also has a plurality of fan blades 380 therein, with the fan blades 380 fixedly mounted to a hub 390 and a fan blade sleeve 400. Positioned between the diffusion tubes 350, 360 is a motor 410. The motor 410 also has a drive shaft 420 and a friction rotor 430. The friction rotor 430 is positioned within the notch 370 on both diffusion tubes 350, 360 so as to drive the fan blade sleeves 400 in both diffusion tubes 350, 360 at the same time in a friction drive. The single motor 410 thus drives the fan blades 380 in both the intake and the exhaust diffusion tubes 350, 360.

FIG. 8 shows a possible application of the diffusion tube embodiments of FIGS. 3 through 7. FIG. 8 shows a battery casing 440 with a plurality of metal-air cells 442 positioned therein. The battery casing 440 also includes an air plenum 444 with a partition 446. The dual diffusion tube concept of FIG. 7 is employed herein, although any of the other embodiments would be applicable. Specifically, the motor 410 is positioned between the intake diffusion tube 350 and the exhaust diffusion tube 360. When the motor 410 is on, the fan blades 380 within the intake diffusion tube 350 draw ambient air into the casing 440. The air travels into the air plenum 444, around the partition 446, and out of the exhaust diffusion tube 360. When the fan motor 410 is off, the diffusion tubes 350, 360 are of sufficient length so as to eliminate substantially air flow therethrough.

By placing the fan blades 380 within the tubes 350, 360 with the motor 410 placed outside of the tubes 350, 360, this embodiment therefore provides a relatively small diameter diffusion tube 350, 360 with the ability to provide an significant amount of intake air. This ability to provide a significant amount of air through a long narrow tube also provides an increased isolation ratio. Further, the power required to drive the fan blades 380 is limited to the one motor 410, thereby increasing the overall energy efficiency of the battery.

FIG. 9 shows an alternative embodiment to the motor driven fans of FIGS. 2-8. FIG. 9 shows a diffusion tube 450 with one or more fan blades 460 positioned therein. The fan blades 460 are mounted onto a hub 470. Mounted on a first side of the diffusion tube 450 is a first strut 480 and mounted on a second side of the diffusion tube 450 is a second strut 490. The struts 480, 490 may be any type of anchoring device that also permits the passage of an adequate amount of air. Connected between the first strut 480 and the hub 470 of the fan blades 460 is an actuator 495. In this case the actuator 495 is a first shape memory alloy (“SMA”) wire 500. Attached between the second strut 490 and the hub 470 of the fan blades 460 is a second SMA wire 510.

By “shape memory alloy wire” 500, 510, we mean a wire, generally nitinol alloys with nearly equal atomic amounts of nickel and titanium, that is made to “remember” a particular shape. Such a SMA wire is formed at low temperatures to the desired shape, clamped, and then heated past its transformation temperature to its annealed temperature. When cooled, the SMA wire can be easily deformed. Thereafter, the wire will return to its annealed shape when heated. After the heat source is removed, the wire can be forced back to its deformed shape and the cycle can be repeated. A SMA wire can thus provide mechanical movement without the use of a traditional motor. A preferred shape memory alloy wire is sold by Dynalloy, Inc. of Erin, Calif. under the trademark “Flexinol” actuator wires.

In this case, the wires 500, 510 are formed with an annealed shape having a given rotation. One of the wires 500, 510 is then deformed in the opposing direction. The wires 500, 510 are then installed into the diffusion tube 450 with this opposing rotation. When an electrical current, heat, or other type of energy is applied to the deformed wire 500, 510, the wire 500, 510 returns to its nondeformed or annealed shape. The wires 500, 510 generally are heated one at a time, such that heating one wire 500, 510 to its annealed shape forces the second wire 500, 510 back to its deformed state and vise-versa.

Specifically, a first electric circuit 520 is completed along the first SMA wire 500 between the first strut 480 and the hub 470 of the fan blades 460. A second electric circuit 530 is completed along the second SMA wire 510 between the second strut 490 and the hub 470 of the fan blade 460. The first SMA wire 500 is deformed in the opposite rotational direction to its annealed shape. With the application of a voltage pulse to the first SMA wire 500, the wire 500 torsionally returns to its annealed shape. This motion in the wire 500 rotates the hub 470 and the fan blades 460. The rotation of the hub 470 also torsionally deforms the second SMA wire 510. Likewise, with the application of a voltage pulse to the second SMA wire 510, the second wire 510 returns to its annealed configuration, thereby rotating the hub 470 and the fan blades 460 in the opposite direct and torsionally deforming the first SMA wire 500.

This oscillating process repeats itself and causes an oscillating bi-directional flow of air through the diffusion tube 450. Because of the bidirectional flow, only one diffusion tube 450 may be required to operate the battery. Further, the use of the shape memory alloy wires 500, 510 shown herein may eliminate the need for a typical fan motor. Alternatively, only a first SMA wire 500 may be used with the second wire 510 simply storing rotational energy as a torsional spring. Other types of actuator devices may be used, such as bi-metal elements, solenoids, piezo-electric elements, and the like known to those skilled in the art.

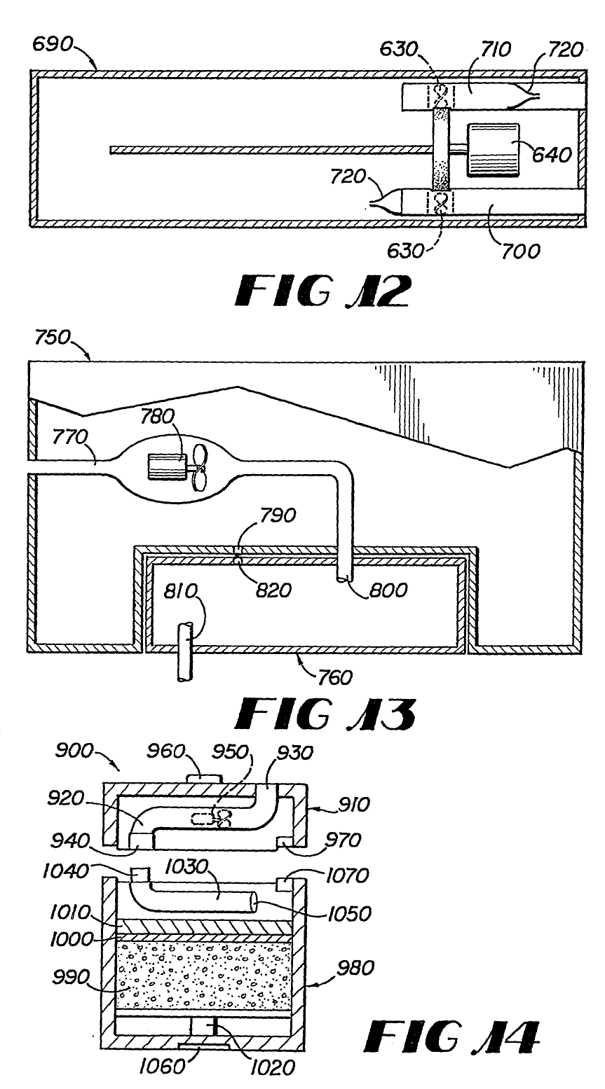

FIGS. 10 and 11 show another application of the present invention. These figures show a battery cell 550 that is approximately “AA” size. The cell 550 has an outer air electrode, an anode layer 560, surrounding an inner air electrode, a cathode layer 570. Positioned within the middle of the cell 550 is an air intake passageway 580 and an air exhaust passageway 590. Positioned on top of the cell 550 is an air manager 600. The air manager 600 includes a convoluted intake tube 610 and a convoluted exhaust tube 620. By “convoluted”, we mean that the tubes 610, 620 are either wound within the air manager 600 or packed therein in “accordion” style. The purpose of the convoluted tubes 610, 620 is to lengthen the air intake path and exhaust path as long as possible so as to provide adequate isolation to the cell 550. The tubes 610, 620 have a diameter of approximately 0.05-0.20 cm each and a length of approximately 0.2-2.0 cm each. The only positioning requirement of the convoluted intake and exhaust tubes 610, 620 is that they do not completely fold together so as to cut off the air pathways 580, 590.

Positioned within each tube 610, 620 is a plurality of fan blades 630 fixed within a fan blade sleeve 635 as described above. The fan blades 630 are sized to the diameter of the tubes 610, 620. Positioned between the tubes 610, 620 is a motor 640 as described above. The motor 640 includes a drive shaft 650 and a friction rotor 660. The motor 640 disclosed herein is a 1.5 volt electrical motor that occupies about one cubic centimeter of space. Each tube 610, 620 likewise contains a notch 690 such that the friction rotor 660 of the motor 640 drives both fan blade sleeves 635 to provide the intake air flow and the exhaust air flow through the cell 550. Although both intake and exhaust fan blades 630 are shown, only the intake fan blades 630 are required.

In this embodiment, the fan blades 630 provide a sufficient airflow in an AA size battery cell. The motor 640 drives the fan blades 630 to provide about 5 to 500 cubic centimeters of air per minute to the cell 550. When the motor 640 is off and the fan blades 630 are still, less than about 0.001 cubic centimeters of air per minute reach the cell. Further, when compared to a cell with no air manager, the use of the convoluted intake and exhaust tubes 610, 620 with the internal fan blades 630 provides an isolation ratio of more than 100 to 1. This embodiment thus provides a zinc-air cell in a conventional AA size.

A further embodiment of the present invention is shown in FIG. 12. This embodiment has the same AA size as described above. Instead of the convoluted intake and exhaust tubes 610, 620, this embodiment shows a cell 690 with a collapsible tube 720 on the intake and the exhaust fan openings 700, 710. By a “collapsible” tube we mean that the area of the pathway is decreased along a sufficient portion of its length when unsupported such that the diffusion rate of water vapor through this path is reduced. Because the diffusion rate is proportional to the area of the opening divided by the length, the collapsible tube 720 can offer a highly restrictive path. The collapsible tube 720 acts largely as a one way valve. The collapsible tube 720 remains substantially closed when the fan motor 640 is off but opens up sufficiently under pressure of air when the fan blades 630 rotate to force the passage of air therethrough.

The collapsible tube 720 may be made from thin, lightweight materials such that it is easily opened and supported by air pressure. For example, polyester and nylon are available as thin, lightweight plastic films that can be fabricated in the desired shape. These materials can be oriented in the fabrication process so that they are biased in closed orientation. This allows the materials to return to the collapsed positioned after being opened. In addition, the static attraction of these materials may act to minimize the area of the collapsed opening. Similarly, an elastomeric material, such as latex, could be used to fabricate a thin collapsible tube. The mechanical properties of this material allow it to collapse to a closed position after it has been opened by air pressure. Similarly, the water vapor transmission properties of the collapsible tube 720 can be further reduced by using materials that either have low water vapor transmission rates or by otherwise coating them with materials that have this property. For example, the materials may be metallized. The collapsible tube 720 thus provides a cell 690 with a high isolation ratio when the fan blades 630 are still but permits adequate flow therethrough when the fan blades 630 are rotating.

A further embodiment of the present invention is shown in FIG. 13. This embodiment shows an electronic device 750 powered by a metal-air battery 760. The electronic device 750 includes an intake diffusion tube 770 with an internal fan 780. The intake diffusion tube 770 is in communication with the atmosphere and the metal-air battery 760. The electronic device 750 also includes a positive and a negative battery terminal 790. Similarly, the metal-air battery 760 includes an intake diffusion tube 800 that is sized to mate with the intake diffusion tube 770 of the electronic device 750. The metal-air battery 760 also includes an exhaust diffusion tube 810 vented to the atmosphere or, alternatively, back through the electronic device 750. The metal-air battery also has a positive and a negative battery terminal 820. The metal-air battery 760 is sized to fit within or adjacent to the electronic device 750 such that the respective diffusion tubes 770, 800 and the respective battery terminals 790, 820 are in contact and communication.

A preferred method of coupling the battery 760 and the electronic device 750 is shown a commonly-owned application entitled “Air-Managing System For Metal-Air Battery Using Resealable Septum” (Attorney Docket 01446-1070) filed concurrently herewith, entitled “Replaceable Metal-Air Cell Pack With Self-Sealing Adaptor”. This application describes the mating of a diffusion tube split between an electrical device and a metal-air battery with a needle and septum relationship. The end to the diffusion tube within the electrical device is fitted with a hollow needle while the end of the diffusion tube in the metal-air battery is covered with a septum. The septum substantially prevents air from reaching the metal-air battery. When the electrical device and the metal-air battery are connected, the hollow needle penetrates through the septum in the metal-air battery so as to permit air flow therethrough. When the devices are separated, the septum closes in a substantially air tight manner so as to prevent air flow to the battery.

In use, air is drawn into the intake diffusion tube 770 of electronic device 750 by the fan 780. The air then passes into the metal-air battery 760 via the intake diffusion tube 800 and circulates through the metal-air battery 760. The air then passes out of the exhaust diffusion tube 810 back to the atmosphere. Electric power is provided to the electronic device 750 from the metal-air battery 760 via the respective battery terminals 820, 790. By placing the fan 780 within the electronic device 750, as opposed to within the metal-air battery 760 itself, a relatively small metal-air battery 760 is possible. The battery 760 is both small and relatively inexpensive to replace because the fan 780 is stationary within the electronic device 750 and need not be replaced each time the battery 760 is exhausted. Further, because the metal-air battery 760 has an intake diffusion tube 800 and an exhaust diffusion tube 810, the battery 760 is properly isolated from the environment during periods of non-use.

A similar embodiment is shown in FIG. 14. FIG. 14 shows an AA size cell 900. The cell 900 has an air manager cap 910 with a cap diffusion tube 920 extending from an air inlet 930 communicating with the atmosphere to a cap mating connector 940. Positioned within the cap diffusion tube 920 is a fan 950 or other types of air movement devices similar to that described above. The fan 950 may be capable of producing a reciprocating airflow. The air manager cap 910 also includes a positive cell terminal 960 and a cap battery connector 970. The cell 900 further includes a replaceable chemistry body 980 for mating with the air manager cap 910. Positioned within the chemistry body 980 may be a zinc paste anode material 990, a separator layer 1000, and a cathode layer 1010. The zinc paste anode material 990, the separator layer 1000, and the cathode layer 1010 are of conventional design. The zinc paste anode material 990 is kept in contact with the separator layer 1000 via a spring-loaded gantry 1020 or other types of conventional compressible elements to maintain a mechanical interface with the zinc paste. The chemistry body 980 also includes a body diffusion tube 1030. The body diffusion tube 1030 extends from a body mating connector 1040 designed to mate with the cap mating connector 940 to an air outlet 1050 positioned adjacent to the cathode layer. The chemistry body 980 also includes a negative cell terminal 1060 and a body battery connector 1070.

In use, air is drawn into the cell 900 through the cap diffusion tube 920 in the air manager cap 910 via the air inlet 930. The air is drawn into the cap diffusion tube 920 via the fan 940 positioned therein. The air passes through the cap diffusion tube 920 and into the chemistry body 980 and the body diffusion tube 1030 via the respective mating connectors 940, 1040. The air then exits the air outlet 1050 adjacent to the cathode layer 1010. After a sufficient amount of intake air has been forced into the chemistry body 980, the fan 950 may reverse direction. Exhaust air is then forced into the air outlet 1050, through the respective diffusion tubes 920, 1030 and out of the air inlet 930. After the zinc paste anode material 990 is exhausted, the chemistry body 980 may be removed from the air manager cap 910. The air manager cap 910 may then be attached to a fresh chemistry body 980. Current flows through the cell 900 via the respective battery connectors 970, 1070. The cell 900 may provide electrical power to a circuit via the respective cell terminals 960, 1060.

Either both of the respective diffusion tubes 920, 1030 or only the body diffusion tube 1030 may serve as the isolating pathway for the cell 900 as a whole. Because the body diffusion tube 1030 acts as an isolating pathway, the chemistry body 980 may have a long shelf life without being sealed or connected to the air manager cap 910. Alternatively, the cap diffusion tube 920 may act as the isolating pathway if the body diffusion tube 1030 is sealed when not connected to the air manager cap 910. Numerous variations on this embodiment may be used. For example, the chemistry body 980 may use both an intake and an exhaust diffusion tube as opposed to a reciprocating fan.

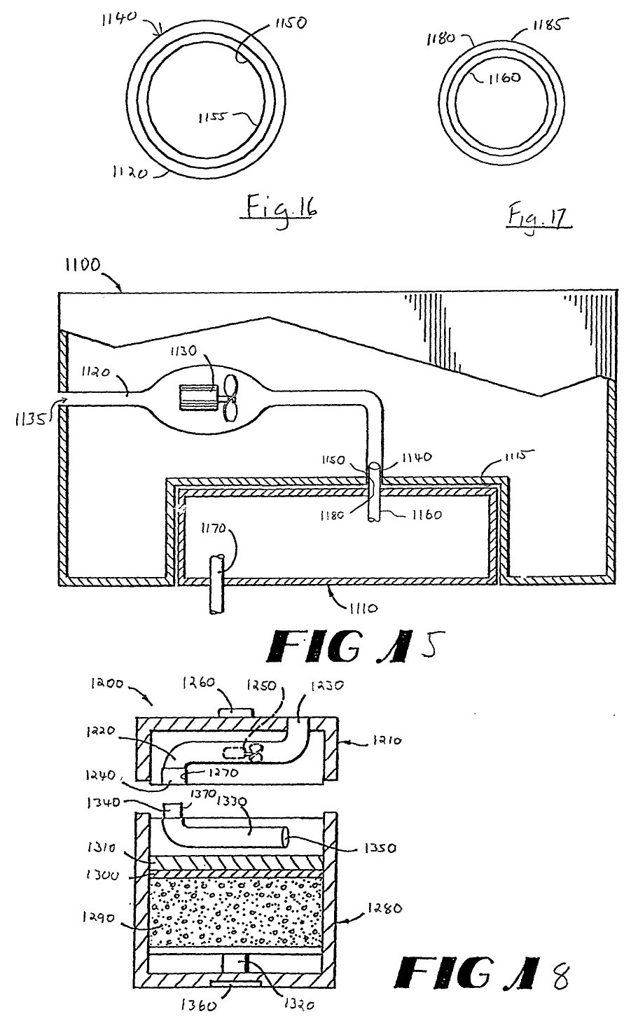

Further embodiments of the present invention are shown in FIGS. 15-18. FIG. 15 shows an electronic device 1100 similar to the electronic device 750 of FIG. 13. The electronic device 1100 is powered by a metal-air battery 1110 positioned within a battery port 1115. The electronic device 1100 may include an intake diffusion tube 1120. The intake diffusion tube 1120 may include an internal fan 1130 positioned therein or adjacent thereto. The intake diffusion tube 1120 is in communication with the atmosphere at an atmosphere end 1135 and with the metal-air battery 1110 at a connection end 1140.

The electronic device 1100 also includes a positive and a negative battery terminal 1150. As is shown in FIG. 16, the battery terminal 1150 may be positioned within the diffusion tube 1120 at the connection end 1140. In this embodiment, the battery terminal 1150 is in the form of a ring-shaped element 1155. The ring-shaped element 1155 is slightly less in diameter than the intake diffusion tube 1120 and is fixedly attached therein. Although the battery terminal 1150 is described as the ring shaped element 1155, the battery terminal 1150 may be in any convenient shape. Alternatively, the battery terminal 1150 may be an integral element with the diffusion tube 1120. As is shown in FIG. 15, the battery terminal 1150 may be at least the connection end 1140 of the diffusion tube 1120. The battery terminal 1150 and the connection end 1140 of the diffusion tube 1120 thus may be made from any conductive material such as copper, aluminum, and the like typically used as battery terminals by those skilled in the art. The battery terminal 1150 may be divided into negative and positive areas in any convenient fashion. Alternatively, multiple terminals 1150 may be used.

The metal-air battery 1110 includes an intake diffusion tube 1160 and an out-take diffusion tube 1170. The intake diffusion tube 1160 also has a positive and a negative battery terminal 1180 positioned thereabout. As is shown in FIG. 17, the battery terminal 1180 may be positioned about the intake diffusion tube 1160. In this embodiment, the battery terminal 1180 is in the form of a ring-shaped element 1185. The ring-shaped element 1185 is of slightly greater diameter than the intake diffusion tube 1160 and is fixedly attached thereabout. Although the battery terminal 1180 is described as the ring shaped element 1185, the battery terminal 1180 may be in any convenient shape. Alternatively, the battery terminal 1180 may be an integral element with the diffusion tube 1160 as is shown in FIG. 15. The battery terminal 1180 and the diffusion tube 1160 thus may be made from any conductive material such as copper, aluminum, and the like typically used as battery terminals by those skilled in the art. The battery terminal 1180 may be divided into negative and positive areas in any convenient fashion. Alternatively, multiple terminals 1180 may be used.

The diffusion tube 1160 of the metal-air battery 1110, with or without the ring-shaped element 1185, is of slightly lesser diameter than the connection end 1140 of the diffusion tube 1120 of the electronic device 1100, with or without the separate ring shaped element 1155. The diffusion tube 1160 (with or without the separate ring shaped element 1155) therefore may fit securely within the connection end 1140 of the diffusion tube 1120 of the electrical device 1100 (with or without the ring-shaped element 1185) such that the battery terminals 1150, 1180 are in electrical contact. It is important to note that although the diffusion tube 1120 of the electronic device 1100 is described as being greater in diameter than the diffusion tube 1160 of the metal-air battery 1110, the reverse situation also could be used.

The metal-air battery 1110 is sized to fit within or adjacent to the electronic device 1100 such that the respective diffusion tubes 1120, 1160 and the respective battery terminals 1150, 1180 are in contact and communication. Electric power thus is provided to the electronic device 1100 from the metal-air battery 1110 via the respective battery terminals 1150, 1180 positioned within, around, or as a part of, the diffusion tubes 1120, 1160. The diffusion tubes 1120, 1160 thus act as both the air and electrical connection means between the electronic device 1100 and the metal-air battery 1110. Further, the diffusion tubes 1120, 1160 serve to physically connect these elements.

It is important to note that although both the electronic device 1100 and the metal-air battery 1110 have been described herein as using a single diffusion tube 1120, 1160, multiple diffusion tubes may be used. For example, both the electronic device 1100 and the metal-air battery 1110 may have an input diffusion tube 1120, 1160 and a separate output diffusion tube 1120, 1160. Any number of diffusion tubes 1120, 1160 may be used. Given separate diffusion tubes 1120, 1160, one set of tubes 1120, 1160 may contain the positive battery terminals 1150, 1180 and another set of diffusion tubes 1120, 1160 may contain the negative battery terminals 1150, 1180. In fact, the terminals 1150, 1180 may be positioned on any flow path between the electronic device 1100 and the metal-air battery 1110.

A similar embodiment is shown in FIG. 18. FIG. 18 shows an AA size cell 1200 similar to the AA size cell 900 of FIG. 14. The cell 1200 has an air manager cap 1210 with a cap diffusion tube 1220 extending from an air inlet 1230 communicating with the atmosphere to a cap mating connector 1240. Positioned within the cap diffusion tube 1220 is a fan 1250 or other type of air movement device. The air manager cap 1210 also includes a positive cell terminal 1260 and a cap battery connector 1270. The cap battery connector 1270 may be positioned within the cap mating connector 1240 as is shown in FIG. 16 with the use of the ring-shaped element 1155 or a similar structure. Alternatively, the cap battery connector 1270 may be a unitary element with the cap mating connector 1240 as is shown in FIG. 18. The cap battery connector 1270 and the cap mating connector 1240 thus may be made from conductive materials such as copper, aluminum, and the like. The cap battery connector 1270 may be divided into negative and positive areas in any convenient fashion. Alternatively, multiple connectors 1270 may be used. The cap battery connector 1270 is in communication with the positive cell terminal 1260.

The cell 1200 further includes a replaceable chemistry body 1280 for mating with the air manager cap 1210. Positioned within the chemistry body 1280 may be a zinc paste anode material 1290, a separator layer 1300, and a cathode layer 1310. The zinc paste anode material 1290, the separator layer 1300, and the cathode layer 1310 are of conventional design. The zinc paste anode material 1290 is kept in contact with the separator layer 1300 via a spring loaded gantry 1320 or other conventional types of compressible elements to maintain a mechanical interface with the zinc paste.

The chemistry body 1280 also includes a body diffusion tube 1330. The body diffusion tube 1330 extends from a body mating connector 1340 designed to mate with the cap mating connector 1240 to an air outlet 1350 positioned adjacent to the cathode 1310. The chemistry body 1280 also may include a negative cell terminal 1360 and a body battery connector 1370. The body battery connector 1370 may be positioned about the body mating connector 1340 as is shown in FIG. 17 with the use of the ring-shaped element 1185 or a similar structure. Alternatively, the body battery connector 1370 may be a unitary element with the body mating connector 1340 as is shown in FIG. 18. The body battery connector 1370 and the body mating connector 1340 thus may be made from conductive materials such as copper, aluminum, and the like. The body battery connector 1370 may be divided into negative and positive areas in any convenient fashion. Alternatively, multiple connectors 1370 may be used. The negative cell terminal 1360 is in communication with the body battery connector 1370.

The cap mating connector 1240 (as a one-piece element or a two piece element) may be of slightly greater diameter than the body mating connector 1340 (as a one-piece element or a two piece element). The cap mating connector 1240 therefore may fit securely within the body mating connector 1340 such that the battery connectors 1270, 1370 are in electrical contact. It is important to note that although the cap mating connector 1240 is described as being greater in diameter than body mating connector 1340, the reverse situation also could be used.

When the air manager cap 1210 is positioned on the chemistry body 1280, the respective diffusion tubes 1220, 1330 are joined via the cap mating connector 1240 and the body mating connector 1340. Likewise, the air manager cap 1210 and the chemistry body 1280 are electrically joined via the respective battery connectors 1270, 1370. The cell 1200 therefore may provide electrical power to a circuit via the respective cell terminals 1260, 1360. The diffusion tubes 1220, 1330 thus act as both the air and electrical connection means between the air manager cap 1210 and the chemistry body 1280. Further, the diffusion tubes 1220, 1330 serve to physically connect these elements.

Similar to the electronic device 1100 and the metal-air battery 1110 described above, although the air manger cap 1210 and the chemistry body 1280 have been described herein as using a single diffusion tube 1220, 1330, multiple diffusion tubes may be used. For example, both the air manger cap 1210 and the chemistry body 1280 may have an input diffusion tube 1220, 1330 and a separate output diffusion tube 1220, 1330. Any number of diffusion tubes 1220, 1330 may be used. Given separate diffusion tubes 1220, 1330, one set of tubes 1220, 1330 may contain the positive battery connectors 1270, 1370 and another set of diffusion tubes 1220, 1330 may contain the negative battery connectors 1270, 1370. In fact, the terminals 1270, 1330 may be positioned on any flow path between the air manger cap 1210 and the chemistry body 1280.

The preferred capacity of the diffusion tubes described herein for passing airflow in response to operation of fan in the various embodiments depends upon the desired capacity of the metal-air cells. Any number diffusion tubes can be used such that the aggregate airflow capacity of multiple diffusion tubes equals a preferred total airflow capacity. Those skilled in the art will appreciate that the length of the diffusion tubes may be increased, and/or the diameter decreased, if the differential pressure created by the air-moving device is increased. A balance between the differential pressure created by the air moving device and the dimensions of diffusion tubes can be found at which airflow and diffusion through diffusion tubes will be sufficiently reduced when the air moving device is not forcing air through the diffusion tube.

Whether utilized for one-way flow or reciprocating flow, the diffusion tubes as described herein may be isolating passageways as described above and in commonly owned U.S. Pat. No. 5,691,074. The terms “diffusion tubes” and “isolating passageway” are used synonmously herein. The isolating passageways are sized to (i) pass sufficient airflow therethrough in response to operation of the fan or the air moving device so that the metal-air cells provide an output current for powering a load, but (ii) restrict airflow and diffusion while the diffusion tubes are unsealed and the fan is not forcing airflow therethrough, so that the cells or the oxygen electrodes are at least partially isolated from the ambient air. The diffusion tubes maintain a constant humidity level such that the internal water vapor protects the oxygen electrodes of the cell. These diffusion tubes preserve the efficiency, power and lifetime of the metal-air cells. Each diffusion tube provides an isolation function while at least partially defining an open communication path between the ambient air and the cells or the oxygen electrodes. The diffusion tubes therefore provide an isolation function without requiring a traditional air door or doors, or the like, to seal the diffusion tubes.

Although the diffusion tubes restrict airflow and diffusion while the fan is not forcing airflow therethrough, it is desirable in some systems to permit a limited amount of diffusion through the diffusion tubes while the fan is not on. For example, for secondary or rechargeable metal-air cells it is preferred for the diffusion tubes to allow for diffusion of oxygen away from the cells or the oxygen electrodes to the ambient environment. As another example, in some circumstances it is desirable for at least a limited amount of oxygen to diffuse from the ambient air through the diffusion tubes to the oxygen electrodes. This diffusion maintains a consistent “open cell voltage” and minimizes any delay that may occur when the metal-air cells transition from a low or no current demand state to a maximum output current.

The diffusion tubes are preferably constructed and arranged to allow a sufficient amount of airflow therethrough while the fan is operating so that a sufficient output current, typically at least 50 ma, and preferably at least 130 ma, can be obtained from the metal-air cells. In addition, the diffusion tubes are preferably constructed to limit the airflow and diffusion therethrough such that the leakage or drain current that the metal-air cells are capable of providing while the fan is off is smaller than the output current by a factor of about 50 or greater, as described above. In addition, diffusion tubes are preferably constructed to provide an “isolation ratio” of more than 50 to 1, as described above. Such isolation ratios provide a relatively high powered metal-air battery with a longer shelf life. Further, the volumetric energy density of the battery as a whole may be increased because the volume of space allocated to the air plenum and the fan may be reduced.

From the foregoing description of the preferred embodiments and the several alternatives, other alternative constructions of the present invention may suggest themselves to those skilled in the art. Therefore, the scope of the present invention is to be limited only by the claims below and the equivalence thereof.

We claim:

1. An electronic device driven by a metal-air battery, said metal-air comprising a battery diffusion pathway in contact with a battery terminal, said electronic device comprising:
a device diffusion pathway in communication with said battery diffusion pathway of said metal-air battery; and
a device battery terminal in contact with said device diffusion pathway, said battery device terminal in contact with said battery terminal of said metal-air battery for communicating electrical power from said metal-air battery to said electronic device.

2. The electronic device of claim 1, wherein said device battery terminal comprises an electrically conductive material.

3. The electronic device of claim 1, wherein said device battery terminal comprises a ring element positioned in contact with said device diffusion pathway.

4. The electronic device of claim 3, wherein said device battery terminal comprises said ring element positioned within said device diffusion pathway.

5. The electronic device of claim 1, wherein said device battery terminal comprises a unitary element with said device diffusion pathway.

6. The electronic device of claim 1, wherein said device diffusion pathway comprises a fan positioned therein.

7. The electronic device of claim 1, further comprising a battery port for mating with said metal-air battery.

8. The electronic device of claim 1, wherein said device diffusion pathway comprises a plurality of diffusion pathways.

9. The electronic device of claim 8, wherein said device battery terminal comprises a plurality of battery terminals and wherein each of said plurality of diffusion pathways comprises one of said plurality of battery terminals.

10. The electronic device of claim 1, wherein said device diffusion pathway comprises an input diffusion pathway and an output diffusion pathway and wherein said device battery terminal comprises a first battery terminal in contact with said input diffusion pathway and a second battery terminal in contact with said output diffusion pathway.

11. An metal-air battery for powering an electronic device, said electronic device comprising a device diffusion pathway in contact with a device battery terminal, said metal-air battery comprising:
a diffusion pathway in communication with said device diffusion pathway of said electronic device; and
a battery terminal in contact with said diffusion pathway, said battery terminal in contact with said device battery terminal of said electronic device for communicating electrical power from said metal-air battery to said electronic device.

12. The metal-air battery of claim 11, wherein said battery terminal comprises an electrically conductive material.

13. The metal-air battery of claim 11, wherein said battery terminal comprises a ring element positioned in contact with said diffusion pathway.

14. The metal-air battery of claim 13, wherein said battery terminal comprises said ring element positioned about said diffusion pathway.

15. The metal-air battery of claim 11, wherein said battery terminal comprises a unitary element with said diffusion pathway.

16. The metal-air battery of claim 11, wherein said diffusion pathway comprises a plurality of diffusion pathways.

17. The metal-air battery of claim 16, wherein said battery terminal comprises a plurality of battery terminals and wherein each of said plurality of diffusion pathways comprises one of said plurality of battery terminals.

18. The metal-air battery of claim 11, wherein said diffusion pathway comprises an input diffusion pathway and an output diffusion pathway and wherein said battery terminal comprises a first battery terminal in contact with said input diffusion pathway and a second battery terminal in contact with said output diffusion pathway.

19. An electronic device, comprising:
a battery port;
a device intake diffusion pathway;
said device diffusion pathway comprising a device battery terminal; and
a metal-air battery positioned within or adjacent to said battery port;
said metal-air battery comprising a battery diffusion pathway;
said battery diffusion pathway comprising a battery terminal for contacting said device battery terminal; and
said battery diffusion pathway sized for mating with said device diffusion pathway such that air and electrical power pass along said device diffusion pathway and said battery diffusion pathway.

20. A metal-air cell, comprising:
a chemistry body;
said chemistry body comprising a body diffusion pathway;
said body diffusion pathway comprising a body electrical terminal; and
an air manager cap;
said air manager cap comprising a cap diffusion pathway;
said cap diffusion pathway comprising a cap electrical terminal; and
said cap diffusion pathway and said body diffusion pathway being sized for engagement with each other.

21. The metal-air cell of claim 20, further comprising an air movement device positioned within said cap diffusion pathway.

22. The metal-air cell of claim 20, wherein said cap diffusion pathway comprises an air inlet and a cap mating connector.

23. The metal-air cell of claim 20, wherein said body diffusion pathway comprises an air outlet and a body mating connector.

24. The metal-air cell of claim 20, wherein said chemistry body is detachable from said air manager cap.

25. The metal-air cell of claim 20, wherein said body electrical terminal comprises an electrically conductive material.

26. The metal-air cell of claim 20, wherein said cap electrical terminal comprises an electrically conductive material.

27. The metal-air cell of claim 20, wherein said body electrical terminal comprises a ring element positioned in contact with said body diffusion pathway.

28. The metal-air cell of claim 20, wherein said body electrical terminal comprises a unitary element with said body diffusion pathway.

29. The metal-air cell of claim 20, wherein said cap electrical terminal comprises a ring element positioned in contact said cap diffusion pathway.

30. The metal-air cell of claim 20, wherein said cap electrical terminal comprises a unitary element with said cap diffusion pathway.

31. The metal-air cell of claim 20, wherein said cap diffusion pathway comprises a plurality of diffusion pathways.

32. The metal-air cell of claim 31, wherein said cap electrical terminal comprises a plurality of cap electrical terminals.

33. The metal-air cell of claim 32, wherein each of said plurality of cap diffusion pathways comprises one of said plurality of cap electrical terminals.

34. The metal-air cell of claim 20, wherein said body diffusion pathway comprises a plurality of diffusion pathways.

35. The metal-air cell of claim 34, wherein said body electrical terminal comprises a plurality of body electrical terminals.

36. The metal-air cell of claim 35, wherein each of said plurality of body diffusion pathways comprises one of said plurality of body electrical terminals.
